(19) United States
(12) Patent Application Publication
(10) Pub. No.: US 2015/0109267 A1
(43) Pub. Date: Apr. 23, 2015

(54) DISPLAY DEVICE

(71) Applicant: Japan Display Inc., Minato-ku (JP)

(72) Inventors: Yoshiro AOKI, Tokyo (JP); Tsutomu HARADA, Tokyo (JP); Takanori TSUNASHIMA, Tokyo (JP); Hirotaka HAYASHI, Tokyo (JP)

(73) Assignee: Japan Display Inc., Minato-ku (JP)

(21) Appl. No.: 14/513,713

(22) Filed: Oct. 14, 2014

(30) Foreign Application Priority Data
Oct. 18, 2013 (JP) 2013-217416

(51) Int. Cl. G09G 3/36

(52) U.S. Cl. CPC G09G 3/3674
USPC 345/205; 345/103

(57) ABSTRACT

According to one embodiment, a display device includes a unit pixel, a scanning line, and first to fourth signal lines. The first to fourth signal lines are extended in a columnar direction and are spaced apart from each other. The first and second signal lines are positioned in a region opposed to first and second pixel electrodes in a row direction. The third and fourth signal lines are positioned in a region opposed to third and fourth pixel electrodes in the row direction.

### CROSS-REFERENCE TO RELATED APPLICATIONS

This application is based upon and claims the benefit of priority from Japanese Patent Application No. 2013-217416, filed Oct. 18, 2013, the entire contents of which are incorporated herein by reference.

### FIELD

Embodiments described herein relate generally to a display device.

### BACKGROUND

In general, for example, a liquid crystal display device is known as a display device. Recently, a mobile application has been rapidly widespread. A smartphone, etc. using a liquid crystal display device are known as the mobile applications. In addition, improvement in display performance represented by higher definition, color purity enhancement, brightness enhancement, etc. in the liquid crystal display device, is strongly required. Lower power consumption to achieve a long-time operation using a battery in the liquid crystal display device is also strongly required.

To meet the contradictory requirements such as enhancement of color purity, enhancement of brightness, lower power consumption, etc., a liquid crystal display device adopting a four-color pixel configuration of RGBW (red, green, blue and white) instead of an ordinary three-color pixel configuration of RGB (red, green, and blue) has been developed and manufactured.

However, when the configuration of so called RGBW stripe pixels (i.e., pixels formed by arraying four RGBW pixels extended in a columnar direction, in a row direction) is adopted as the pixels, however, a problem arises that a shape of a pixel unit is elongated and display uniformity is remarkably degraded. Thus, technology of adopting the configuration of so called RGBW square pixels (i.e., pixels formed by arraying four RGBW square pixels, in square) is adopted as the pixels, has been developed to solve the problem of degradation in the display quality.

Incidentally, in the RGBW square pixels, the number of pixels arrayed in each column is twice as great as that in the RGBW stripe pixels. Accordingly, the number of scanning lines is doubled. However, the time to write a video signal from the signal line to the pixels depends on the number of scanning lines and needs to be shortened as the number of scanning lines is increased. Improvement in horizontal resolution merely increases the number of write lines at a signal line side and does not influence the write time, but the higher resolution and the increase in the frame frequency cause the time to write the video signal to be shortened. Thus, the time to write the video signal cannot be sufficiently secured or the power consumption in a driving circuit is remarkably increased according to the increase in the drive frequency.

For this reason, technology of providing a scanning line for every two rows of the arrayed pixels and providing two signal lines for every column of arrayed pixels has been developed. The pixels for two rows share one scanning line. The time to write the video signal can be thereby sufficiently secured even if the configuration of the RGBW square pixels is adopted and the drive frequency is increased. In addition, the increase in the power consumption of the driving circuit can be suppressed (i.e., the power consumption can be lowered).

### BRIEF DESCRIPTION OF THE DRAWINGS

FIG. 1 is a schematic configuration view showing a liquid crystal display device of the embodiment.

FIG. 2 is a schematic configuration view showing the liquid crystal display device.

FIG. 3 is a plan view showing a schematic configuration of an array substrate shown in FIG. 1 and FIG. 2.

FIG. 4 is a schematic enlarged view of unit pixel shown in FIG. 3.

FIG. 5 is a cross-sectional view of an array substrate shown in FIG. 4 seen along line V-V.

FIG. 6 is an enlarged plan view showing an outer side of a display area in an array substrate in a modified example of the liquid crystal display device of the embodiment and, more specifically, showing a switching circuit.

### DETAILED DESCRIPTION

In general, according to one embodiment, there is provided a display device comprising: a unit pixel comprising a first pixel including a first pixel electrode, a second pixel which is adjacent to the first pixel in a columnar direction and which includes a second pixel electrode, a third pixel which is adjacent to the first pixel in a row direction and which includes a third pixel electrode, and a fourth pixel which is adjacent to the second pixel in the row direction and adjacent to the third pixel in the columnar direction and which includes a fourth pixel electrode; a scanning line extending in the row direction and being electrically connected to the first to fourth pixels; and first to fourth signal lines extending in the columnar direction and being spaced apart from each other. The first signal line is positioned in a region opposed to the first and second pixel electrodes in the row direction, and is electrically connected to the first pixel. The second signal line is positioned in the region opposed to the first and second pixel electrodes in the row direction, and is electrically connected to the second pixel. The third signal line is positioned in a region opposed to the third and fourth pixel electrodes in the row direction, and is electrically connected to the third pixel. The fourth signal line is positioned in the region opposed to the third and fourth pixel electrodes in the row direction, and is electrically connected to the fourth pixel.

A liquid crystal display device of an embodiment will be hereinafter described with reference to the accompanying drawings. The disclosure is a mere example, and arbitrary change maintaining the inventive gist that can be easily conceived by a person of ordinary skill in the art, naturally, falls within the inventive scope. To more clarify the explanations, the drawings may pictorially show width, thickness, shape, etc. of each portion as compared with an actual aspect, but they are mere examples and do not restrict the interpretation of the invention. In the present specification and drawings, elements like or similar to those in the already described drawings may be denoted by similar reference numbers and their detailed descriptions may be arbitrarily omitted.

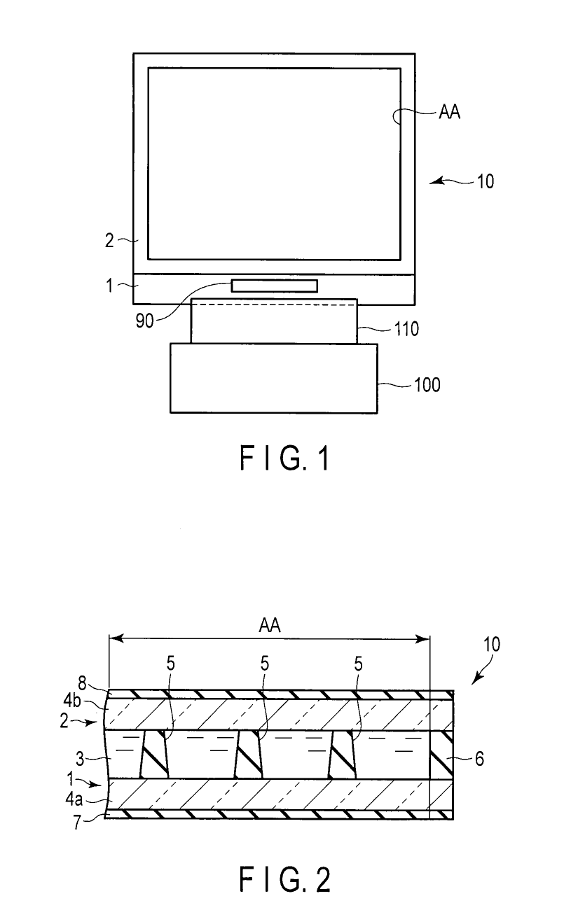

The liquid crystal display device comprises a liquid crystal display panel 10 as shown in FIG. 1 and FIG. 2. The liquid crystal display panel 10 comprises an array substrate 1, a counter-substrate 2 arranged opposite to the array substrate with a predetermined gap, and a liquid crystal layer 3 held between the substrates. Besides these, the liquid crystal display device comprises a first optical module 7 disposed on an outer surface of the array substrate 1, a second optical module 8 disposed on an outer surface of the counter-substrate 2, a signal line driving circuit 90 serving as a video signal output unit, a control module 100, and a flexible printed circuit (FPC) 110. The liquid crystal display panel 10 has a display area AA where pixels PX to be described later are arrayed in a matrix.

As shown in FIG. 1 to FIG. 4, the array substrate 1 comprises, for example, a glass substrate 4a as a transparent insulation substrate. In the display area AA, a plurality of unit pixels UPX arrayed in a matrix are formed above the glass substrate 4a. Number m of unit pixels UPX are arrayed in a row direction X and number n of unit pixels UPX are arrayed in a columnar direction Y orthogonal to the row direction X.

Each of the unit pixels UPX comprises a plurality of pixels PX. Each unit pixel UPX comprises first to fourth pixels PXa to PXd. A second pixel PXb is positioned adjacent to the first pixel PXa in the columnar direction Y. A third pixel PXc is positioned adjacent to the first pixel PXa in the row direction X. The fourth pixel PXd is positioned adjacent to the second pixel PXb in the row direction X and adjacent to the third pixel PXc in the columnar direction Y.

When attention is directed not to the unit of the unit pixels UPX, but to the unit of the pixels PX, number 2m of pixels PX are arrayed in the row direction X and number 2n of pixels PX are arrayed in the columnar direction Y. The second pixels PXb and the fourth pixels PXd are arrayed alternately and sequentially in an odd-number row. The first pixels PXa and the third pixels PXc are arrayed alternately and sequentially in an even-number row. The second pixels PXb and the first pixels PXa are arrayed alternately and sequentially in an odd-number column.

The fourth pixels PXd and the third pixels PXc are arrayed alternately and sequentially in an even-number column.

The unit pixels UPX can be translated into picture elements. In addition, the unit pixels UPX can be translated into pixels. In this case, the pixels PX can be translated into sub-pixels.

A scanning line driving circuit 11 and a pad group (hereinafter called OLB pad group) pG for outer lead bonding are formed above the glass substrate 4a, outside the display area AA.

A plurality of (number n of) scanning lines 15 and a plurality of (number 4m of) signal lines 16 are arranged on the glass substrate 4a, in the display area AA. The signal lines 16 are extended in the columnar direction Y and spaced apart from each other in the row direction X. The scanning lines 15 are extended in the row direction X and are electrically connected to the first to fourth pixels PXa to PXd. The first to fourth pixels PXa to PXd in the plural unit pixels UPX arrayed in the row direction X are electrically connected to the same scanning line 15.

Next, one of the unit pixels UPX will be described.

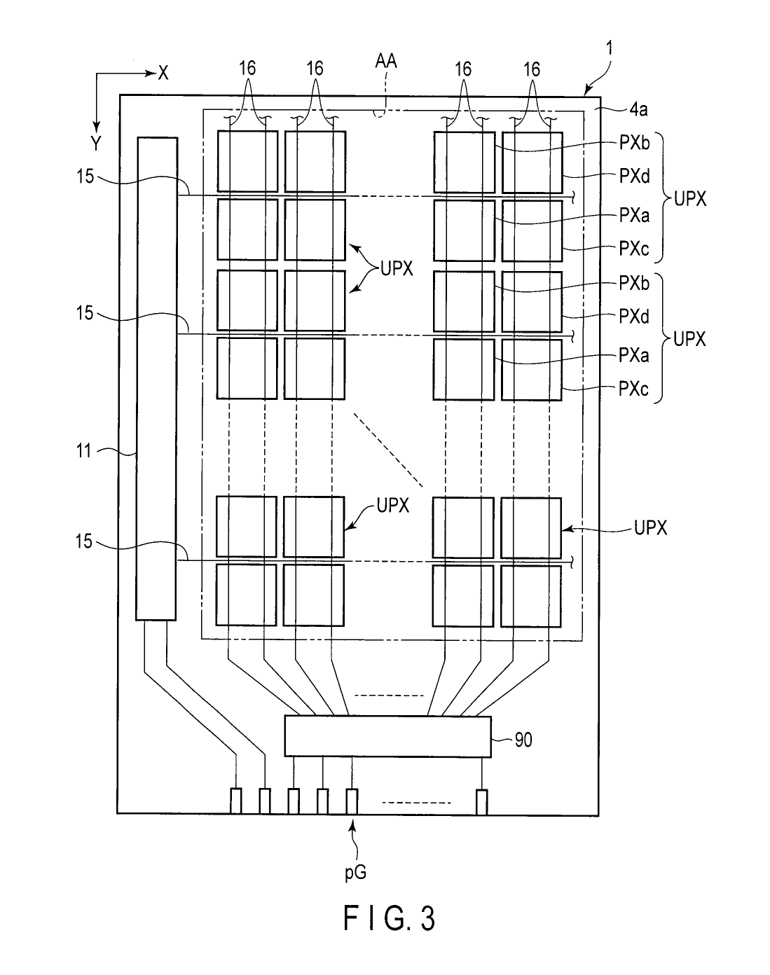

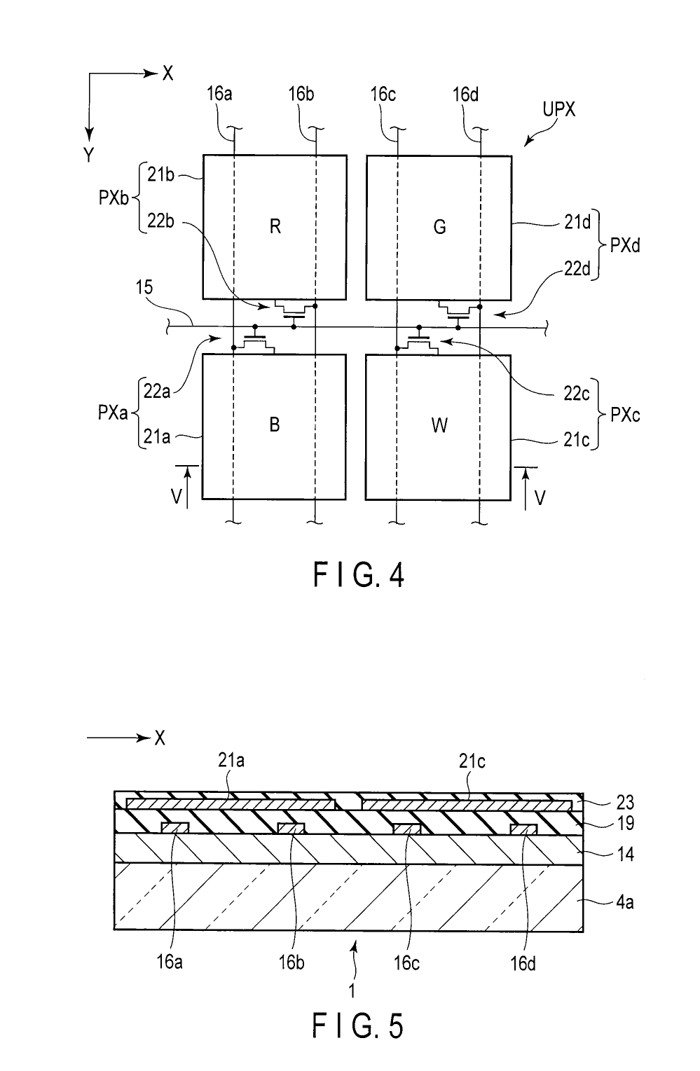

As shown in FIG. 3 and FIG. 4, four signal lines of the plural signal lines 16, i.e., first to fourth signal lines 16a to 16d correspond to the plural unit pixels UPX arrayed in the columnar direction Y.

The first to fourth pixels PXa to PXd are pixels configured to display images of mutually different colors. In the present embodiment, the first to fourth pixels PXa to PXd are pixels configured to display red (R), green (G), blue (B) and white (or transparent, W) images.

The first pixel PXa comprises a first pixel electrode 21a and a first switching element 22a, and is configured to display a blue (B) image. The first switching element 22a is electrically connected to the scanning line 15, the first signal line 16a and the first pixel electrode 21a. In the present embodiment, the first switching element 22a is formed of a thin film transistor (TFT). The first switching element 22a comprises a gate electrode electrically connected to the scanning line 15, a source electrode electrically connected to the first signal line 16a, and a drain electrode electrically connected to the first pixel electrode 21a.

The second pixel PXb comprises a second pixel electrode 21b and a second switching element 22b, and is configured to display a red (R) image. The second switching element 22b is electrically connected to the scanning line 15, the second signal line 16b and the second pixel electrode 21b. In the present embodiment, the second switching element 22b is formed of a TFT.

The second switching element 22b comprises a gate electrode electrically connected to the scanning line 15, a source electrode electrically connected to the second signal line 16b, and a drain electrode electrically connected to the second pixel electrode 21b.

The third pixel PXc comprises a third pixel electrode 21c and a third switching element 22c, and is configured to display a white (W) image. The third switching element 22c is electrically connected to the scanning line 15, the third signal line 16c and the third pixel electrode 21c. In the present embodiment, the third switching element 22c is formed of a TFT. The third switching element 22c comprises a gate electrode electrically connected to the scanning line 15, a source electrode electrically connected to the third signal line 16c, and a drain electrode electrically connected to the third pixel electrode 21c.

The fourth pixel PXd comprises a fourth pixel electrode 21d and a fourth switching element 22d, and is configured to display a green (G) image. The fourth switching element 22d is electrically connected to the scanning line 15, the fourth signal line 16d and the fourth pixel electrode 21d. In the present embodiment, the fourth switching element 22d is formed of a TFT. The fourth switching element 22d comprises a gate electrode electrically connected to the scanning line 15, a source electrode electrically connected to the fourth signal line 16d, and a drain electrode electrically connected to the fourth pixel electrode 21d.

Next, a layered structure of the array substrate 1 (unit pixels UPX, scanning lines 15 and signal lines 16) will be described.

As shown in FIG. 3 to FIG. 5, a base section 14 is formed on a glass substrate 4a. The base section 14 is formed of an undercoating film, first to fourth switching elements 22a to 22d (semiconductor layers, gate insulation film, gate electrodes, etc.), the scanning lines 15, an interlayer insulation film, etc. that are layered in sequence. In the first to fourth switching elements 22a to 22d, the gate electrodes are formed by partially extending the scanning lines 15.

The signal lines 16, etc. are formed on the base section 14. A planarization film 19 is formed on the base section 14 and the signal lines 16. The planarization film 19 has a function of reducing bumps and dips on the surface of the array substrate 1. The first to fourth pixel electrodes 21a to 21d are formed on the planarization film 19. An alignment film 23 is formed on the planarization film 19 and the pixel electrodes 21. The array substrate 1 is formed as described above.

As shown in FIG. 1 and FIG. 2, the counter-substrate 2 comprises, for example, a glass substrate 4b as the transparent insulation substrate. A color filter, a counter-electrode (common electrode) and an alignment film are formed sequentially on the glass substrate 4b, which are not shown in the drawings. The counter-substrate 2 is formed as described above. In the present embodiment, the color filter comprises a blue-colored layer forming the first pixel PXa, a red-colored layer forming the second pixel PXb, a transparent non-colored layer forming the third pixel PXc, and a green-colored layer forming the fourth pixel PXd. The color filter can be formed without the non-colored layer.

As shown in FIG. 2, the gap formed between the array substrate 1 and the counter-substrate 2 is held as a spacer by, for example, a columnar spacer 5. The array substrate 1 and the counter-substrate 2 are bonded to each other by a sealing member 6 arranged at peripheral portions of the substrates. In the present embodiment, the first optical module 7 arranged on the outer surface of the glass substrate 4a and the second optical module 8 arranged on the outer surface of the glass substrate 4b are formed of polarizers. The outer surface of the second optical module 8 is a display surface.

The liquid crystal display device is formed as described above.

The above-described liquid crystal display device is a light reflection type liquid crystal display device. Therefore, the first to fourth pixels PXa to PXd are light reflection type pixels as shown in FIG. 3 to FIG. 5. In the present embodiment, the first to fourth pixel electrodes 21a to 21d are light reflection type electrodes, each comprising a conductive layer formed of a material such as aluminum (Al) having a light reflection property. Thus, the first to fourth pixel electrodes 21a to 21d reflect light made incident on the side of the display surface (i.e., outer surface of the second optical module 8) to the display surface side.

The first to fourth signal lines 16a to 16d will be hereinafter described in detail.

The first to fourth signal lines 16a to 16d are provided on the glass substrate 4a side from the first to fourth pixel electrodes 21a to 21d. In other words, the first to fourth pixel electrodes 21a to 21d are provided on the display surface side from the first to fourth signal lines 16a to 16d.

The first signal line 16a is positioned in a region alone opposed to the first pixel electrode 21a and the second pixel electrode 21b in the row direction X, and is electrically connected to the first pixel PXa (first switching element 22a).

The second signal line 16b is positioned in a region alone opposed to the first pixel electrode 21a and the second pixel electrode 21b in the row direction X, and is electrically connected to the second pixel PXb (second switching element 22b).

The third signal line 16c is positioned in a region alone opposed to the third pixel electrode 21c and the fourth pixel electrode 21d in the row direction X, and is electrically connected to the third pixel PXc (third switching element 22c).

The fourth signal line 16d is positioned in a region alone opposed to the third pixel electrode 21c and the fourth pixel electrode 21d in the row direction X, and is electrically connected to the fourth pixel PXd (fourth switching element 22d).

In the present embodiment, the signal lines 16 (first to fourth signal lines 16a to 16d) are spaced apart from each other at regular intervals in the row direction X. In addition, the signal lines 16 are positioned in a gap at the side edges of the pixel electrodes 21 opposed to the signal lines, in the row direction X.

The liquid crystal display device of the embodiment constituted as described above comprises a plurality of unit pixels UPX, a plurality of scanning lines 15, and a plurality of signal lines 16. Each of the unit pixels UPX comprises the first to fourth pixels PXa to PXd, and the first to fourth pixels PXa to PXd are formed to be arranged in square. Each of the first to fourth pixels PXa to PXd is formed in a substantially square shape.

The scanning lines 15 are electrically connected to the first to fourth pixels PXa to PXd in the plural unit pixels UPX aligned in the row direction X. The signal lines 16 (first to fourth signal lines 16a to 16d) are spaced apart from each other in the row direction X.

Since the liquid crystal display device adopts a configuration of so called RGBW square pixels, degradation in uniformity of display can be suppressed as compared with adoption of the configuration of so called RGBW stripe pixels.

The single scanning line 15 is shared by a plurality of pixels PX (PXa, PXb, PXc and PXd) for two rows, and two lines of the signal lines 16 are arranged for one column of alignment of the plural pixels PX (PXa and PXb, or PXc and PXd). For this reason, the time to write the video signal can be sufficiently secured even if the liquid crystal display device adopts the configuration of the RGBW square pixels and the drive frequency (i.e., frequency of the video signal supplied to the signal lines 16) of the signal lines 16 is increased. In addition, since the number of the scanning lines 15 can be reduced in half, the number of control signals generated by the scanning line driving circuit 11, the controller 100, etc. to drive the scanning lines 15 can be reduced in half. For this reason, increase in the power consumption of the driving circuit (scanning line driving circuit 11) can be suppressed (i.e., lowering the power consumption can be attempted).

Furthermore, in the present embodiment, the single line of the signal lines 16 can be provided for each column of arrangement of the plural pixels PX, and the drive frequency of the signal lines 16 can be reduced in half as compared with the case of connecting the signal line 16 to all of the pixels PX for one column. The increase in the power consumption of an external source IC (a signal line driving circuit 90 and the controller 100) can be thereby suppressed.

The first signal line 16a and the second signal line 16b are positioned in a region alone opposed to the first pixel electrode 21a and the second pixel electrode 21b. The third signal line 16c and the fourth signal line 16d are positioned in a region alone opposed to the third pixel electrode 21c and the fourth pixel electrode 21d. The first pixel electrode 21a and the second pixel electrode 21b function as shielding electrodes for the first signal line 16a and the second signal line 16b, and shield the first signal line 16a and the second signal line 16b from static electricity. The third pixel electrode 21c and the fourth pixel electrode 21d function as shielding electrodes for the third signal line 16c and the fourth signal line 16d, and shield the third signal line 16c and the fourth signal line 16d from static electricity.

In addition, the signal lines 16 do not need to be arranged in a narrow gap of the pixel electrodes 21 (pixels PX), in the row direction X. For this reason, even if two lines of the signal lines 16 are provided for each column of alignment of the pixels PX, coupling capacity which may occur between adjacent signal lines 16 can be suppressed and noise which may be generated at the signal lines 16 can be reduced. Since undesirable variation in a voltage value of the video signal applied to the signal lines 16 can be reduced, the degradation in the display quality can be suppressed.

The signal lines 16 in the present embodiment are spaced apart from each other at regular intervals in the row direction X. Since the intervals of the signal lines 16 are made great to allow the coupling capacity to hardly occur at the signal lines 16, the degradation in the display quality can be further suppressed. Furthermore, even if the coupling capacity occurs between adjacent signal lines 16, the coupling capacity occurring at the signal lines 16 can be balanced and the degradation in the display quality can also be thereby suppressed.

In addition, the pixel electrodes 21 are the light reflection type electrodes and are provided at the display surface side from the signal lines 16. For this reason, the signal lines 16 which are generally formed of a metal and which have a light shielding property do not lower the aperture ratio. For this reason, the light reflection type liquid crystal display device of the present embodiment can attempt increase in the aperture ratio (light reflectivity) as compared with a light transmission type liquid crystal display device.

The signal lines 16 are positioned in a gap at the side edges of the pixel electrodes 21 opposed to the signal lines, in the row direction X. The signal lines 16 are provided to make a margin from the side edges of the pixel electrodes 21, in consideration of an accuracy of a manufacturing device such as an exposing device. The signal lines 16 can be thereby provided so as not to extend outside the region opposed to the pixel electrodes 21, in the row direction X.

Based on the above, the liquid crystal display device having excellent display quality, which is capable of attempting reduction in the power consumption, can be obtained.

Next, a modified example of the liquid crystal display device of the embodiment will be described.

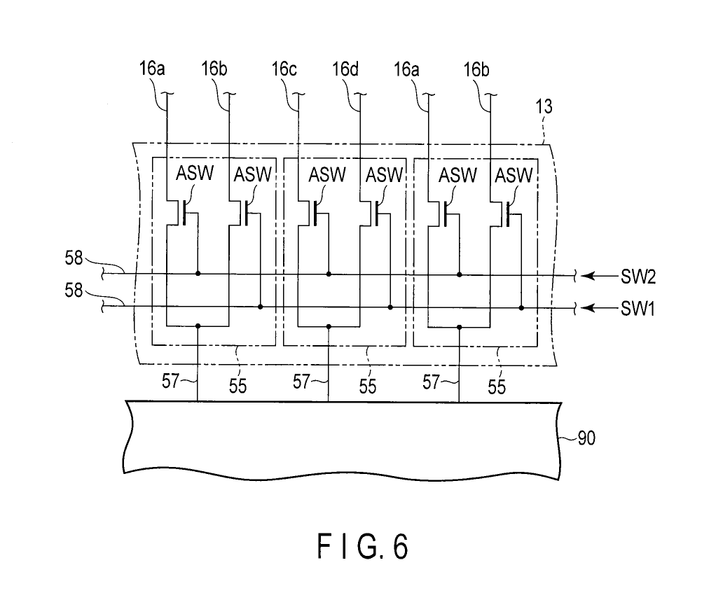

As shown in FIG. 6, the liquid crystal display device may further comprise a changing circuit 13. The changing circuit 13 comprises a plurality of changing element groups 55, and each of the changing element groups 55 comprises a plurality of changing elements ASW. In the present embodiment, each changing element group 55 comprises two changing elements ASW. The changing circuit 13 is a ½-multiplexer circuit. The changing elements ASW are, for example, TFTs and can be formed similarly to the switching elements 22.

The changing circuit 13 is connected to the plural signal lines 16. In addition, the changing circuit 13 is connected to the signal line driving circuit 90 via connection lines 57. The number of the connection lines 57 is a half of the number of the signal lines 16.

Tuning on and off the changing elements (analog switches) ASW is changed by control signals SW1 and SW2 so as to drive two lines of the signal lines 16 for one output (connection line 57) of the signal line driving circuit 90 by time division. Each of the control signals SW1 and SW2 is supplied from the controller 100 to the changing elements ASW via the OLB pad group pG (FIG. 3) and plural control lines 58. The controller 100 supplies each of the control signals SW1 and SW2 to turn on at two times to the changing elements ASW and writes the desired video signal in the pixels PX for two rows, during two horizontal scanning periods.

In the modified example of the liquid crystal display device constituted as described above, the signal lines 16 are driven by time division. For this reason, the drive frequency of the signal lines 16 cannot be reduced in half, unlike the above-described embodiment, but the number of the video signals generated by the signal line driving circuit 90, controller 100, etc. to drive the signal lines 16 can be reduced in half. The increase in the power consumption in the external source IC (signal line driving circuit 90 and controller 100) can be thereby suppressed, similarly to the above-described embodiment.

In addition, even if the signal lines 16 are formed to be driven by time division (i.e., selectively driven) as described above, noise which may occur at the signal lines 16 can be reduced since the signal lines 16 are shielded from static electricity by the pixel electrodes 21.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the first to fourth pixels PXa to PXd may not be formed to display the red, green, blue and white images, but may be formed to display images of mutually different colors and to be capable of synthesizing a white image.

The signal lines 16 (first to fourth signal lines 16a to 16d) may be formed so as not to extend outside the region opposed to the pixel electrodes 21, and may not be spaced apart from each other at regular intervals in the row direction X.

The present embodiment is not limited to the light reflection type liquid crystal display device, but can be variously modified and can be applied to a light transmission type liquid crystal display device. In this case, improvement of the aperture ratio can hardly be attempted, but the liquid crystal display device having excellent display quality, which is capable of attempting reduction in the power consumption, can be obtained.

In addition, the present embodiment is not limited to the liquid crystal display device, but can be applied to various types of display devices capable of displaying images. For example, the above-described embodiment can be applied to any flat panel type display devices such as organic EL (electroluminescent) display devices, other natural light type display devices, electronic paper type display devices comprising cataphoretic elements, etc. It is needless to say that the above-described embodiment can be applied to middle or small display devices and large display devices without particular limitation.

What is claimed is:

1. A display device comprising:
a unit pixel comprising a first pixel including a first pixel electrode, a second pixel which is adjacent to the first pixel in a columnar direction and which includes a second pixel electrode, a third pixel which is adjacent to the first pixel in a row direction and which includes a third pixel electrode, and a fourth pixel which is adjacent to the second pixel in the row direction and adjacent to the third pixel in the columnar direction and which includes a fourth pixel electrode;
a scanning line extending in the row direction and being electrically connected to the first to fourth pixels; and
first to fourth signal lines extending in the columnar direction and being spaced apart from each other,
wherein
the first signal line is positioned in a region opposed to the first and second pixel electrodes in the row direction, and is electrically connected to the first pixel,
the second signal line is positioned in the region opposed to the first and second pixel electrodes in the row direction, and is electrically connected to the second pixel,
the third signal line is positioned in a region opposed to the third and fourth pixel electrodes in the row direction, and is electrically connected to the third pixel, and
the fourth signal line is positioned in the region opposed to the third and fourth pixel electrodes in the row direction, and is electrically connected to the fourth pixel.

2. The display device of claim 1, wherein each of the first to fourth pixels is a light reflection type pixel.

3. The display device of claim 2, wherein the first to fourth pixel electrodes are light reflection type electrodes, and are positioned at a display surface side from the first to fourth signal lines, respectively.

4. The display device of claim 1, wherein the first to fourth pixels are pixels formed to display images of colors different from each other.

5. The display device of claim 4, wherein the first to fourth pixels are a pixel configured to display a red image, a pixel configured to display a green image, a pixel configured to display a blue image, a pixel configured to display a white image.

6. The display device of claim 1, wherein the first to fourth signal lines are spaced apart at regular intervals in the row direction.

7. The display device of claim 1, wherein
the first pixel comprises a first switching element electrically connected to the scanning line, the first signal line and the first pixel electrode,
the second pixel comprises a second switching element electrically connected to the scanning line, the second signal line and the second pixel electrode,
the third pixel comprises a third switching element electrically connected to the scanning line, the third signal line and the third pixel electrode, and
the fourth pixel comprises a fourth switching element electrically connected to the scanning line, the fourth signal line and the fourth pixel electrode.

8. The display device of claim 1, wherein the display device is a liquid crystal display device comprising a liquid crystal layer.
